(19) United States
(12) Patent Application Publication
(10) Pub. No.: US 2019/0224917 A1
(43) Pub. Date: Jul. 25, 2019

(54) Three Dimensional Printing System with Resin Removal Apparatus

(71) Applicant: 3D Systems, Inc., Rock Hill, SC (US)

(72) Inventors: Yashvant Venkatakrishnan, San Diego, CA (US); Andrew Enslow, Escondido, CA (US)

(21) Appl. No.: 16/249,976

(22) Filed: Jan. 17, 2019

Related U.S. Application Data
(60) Provisional application No. 62/620,504, filed on Jan. 23, 2018.

(51) Int. Cl. B29C 64/35; B33Y 10/00; B33Y 30/00; B33Y 50/02; B29C 64/124; B29C 64/245; B29C 64/205; B29C 64/393; B33Y 40/00

(52) U.S. Cl. CPC B29C 64/35; B33Y 10/00; B33Y 30/00; B33Y 50/02; B33Y 40/00; B29C 64/245; B29C 64/205; B29C 64/393; B29C 64/124

(57) ABSTRACT

A three dimensional printing system includes functional modules including a source of empty support trays, a print engine, a spinning apparatus, and a transport system. The source of empty support trays includes at least one support tray which includes a lower planar portion and an upper datum portion. The print engine is configured to receive the empty support tray and to form a three dimensional article of manufacture onto the lower planar portion thereby providing a full support tray. The spinning apparatus includes a plurality of tray holders arranged around a vertical axis of rotation and a motor system for rotating the tray holders about the vertical axis of rotation. The plurality of tray holders include a tray holder having receiving surfaces for receiving the upper datum portion of the full support tray. The transport system is configured to transfer support trays between functional modules.

### CROSS-REFERENCE TO RELATED APPLICATIONS

This non-provisional patent application claims priority to U.S. Provisional Application Ser. No. 62/620,504, Entitled “Three Dimensional Printing System with Resin Removal Apparatus” by Yashvant Venkatakrishnan et al., filed on Jan. 23, 2018, incorporated herein by reference under the benefit of U.S.C. 119(e).

### FIELD OF THE INVENTION

The present disclosure concerns an apparatus and method for fabrication of solid three dimensional (3D) articles of manufacture from radiation curable (photocurable) resins. More particularly, the present disclosure improves post-process removal of uncured photocurable resin from a three dimensional article of manufacture.

### BACKGROUND

Three dimensional (3D) printers are in rapidly increasing use. One class of 3D printers includes stereolithography printers having a general principle of operation including the selective curing and hardening of radiation curable (photocurable) liquid resins. A typical stereolithography system includes a resin vessel holding the photocurable resin, a movement mechanism coupled to a support surface, and a controllable light engine. The stereolithography system forms a three dimensional (3D) article of manufacture by selectively curing layers of the photocurable resin. Each selectively cured layer is formed at a “build plane” within the resin.

Historically stereolithography has been used to produce prototypes. There is a desire to utilize stereolithography in a manufacturing environment with some degree of process and article-handling automation. One challenge is to find an effective and efficient way to remove leftover uncured resin that tends to coat a three dimensional article of manufacture immediately after its manufacture.

### BRIEF DESCRIPTION OF THE FIGURES

FIG. 1 is a block diagram depicting an embodiment of a three dimensional printing system.

FIG. 2 is a schematic diagram depicting an embodiment of a three dimensional print engine.

FIG. 3 is an isometric drawing of an embodiment of a spinning apparatus.

FIG. 4A is a top view of an embodiment of a support tray.

FIG. 4B is a side view of an embodiment of a support tray.

FIG. 5 is an isometric drawing of an embodiment of a tray holder in isolation. The tray holder is for holding a support tray during a spinning process to remove uncured photocurable resin.

FIG. 6A is an isometric drawing that illustrates an embodiment of a loading apparatus in a raised configuration.

FIG. 6B is an isometric drawing that illustrates an embodiment of a loading apparatus in a lowered configuration when loading a support tray into a tray holder.

FIG. 7 is a side view of an embodiment of a tray holder with an empty support tray loaded thereon.

FIG. 8 is an isometric drawing illustrating an embodiment of a spinning system.

FIG. 9 is an isometric drawing illustrating an embodiment of a tray holder supporting a full support tray.

FIG. 10 is a flowchart depicting an exemplary method of loading and operating a spinning system.

### SUMMARY

In a first aspect of the disclosure, a three dimensional printing system includes a source of empty support trays, a print engine, a spinning apparatus, and a transport system. The source of empty support trays includes at least one support tray which includes a lower planar portion and an upper datum portion. The print engine is configured to receive the empty support tray and to form a three dimensional article of manufacture onto the lower planar portion thereby providing a full support tray. The spinning apparatus includes a plurality of tray holders arranged around a vertical axis of rotation and a motor system for rotating the tray holders about the vertical axis of rotation. The plurality of tray holders include at least one tray holder having receiving surfaces for receiving the upper datum portion of the full support tray. The transport system is configured to transfer the empty support tray from the source of support trays to the print engine and to transfer the full support tray from the print engine to the tray holder.

In one implementation the support tray is formed from a magnetic material. The tray holder includes at least one magnet for securing the support tray to the tray holder.

In another implementation the upper datum portion includes two sets of datum portions including a first set of opposed datum portions that extend along a first axis and a second set of opposed datum portions that extend along a second axis. The second axis is perpendicular to the first axis. The first set of datum portions is used by the transport system to hold the full support tray as it is placed into the tray holder. The second set of datum portions engage the receiving surfaces of the tray holder. The second set of datum features are opposed with respect to a radial axis that extends from the vertical axis.

In yet another implementation the transport system includes a first transport mechanism for moving the support tray between the print engine and the spinning system and a second transport mechanism for loading the support tray into the tray holder. The second transport mechanism includes a loading arm that rotates about a single pivot axis to move the support tray from above the spinning apparatus to the tray holder.

In a further implementation the tray holder defines a plane of orientation for the lower planar portion in the spinning apparatus. The plane of orientation has a non-zero polar angle with respect to the vertical axis. The polar angle can be within a range between 30 and 60 degrees or about 45 degrees. The transport system can include a loading arm that rotates about a single axis to move the tray from above the spinner to the tray holder. The angle of rotation of the loading arm correlates to the polar angle and can equal at least 90 degrees minus the polar angle.

In a second aspect of the disclosure a three dimensional printing system includes a source of empty support trays, a print engine, a spinning apparatus, a transport system, and a controller. The source of empty support trays includes at least one support tray which includes a lower planar portion and an upper datum portion. The spinning apparatus includes a plurality of tray holders arranged around a vertical axis of rotation and a motor system for rotating the tray holders about the vertical axis of rotation. The plurality of tray holders include a tray holder having receiving surfaces for receiving the upper datum portion of the full support tray. The controller is configured to (1) operate the transport system to transfer an empty support tray from the source of support trays to the print engine, (2) operate the print engine to form a three dimensional article of manufacture onto a lower surface of the planar portion thereby providing a full support tray, (3) operate the transport system to transfer the full support tray from the print engine to the tray holder whereby the upper datum portion engages the receiving surfaces, and (4) operate the motor system to rotate the full tray to remove uncured resin from the three dimensional article of manufacture.

In one implementation the controller includes a processor and an information storage device. The information storage device includes a non-transient or non-volatile portion that stores software instructions to be executed by the processor. When executed by the processor, the software instructions control various portions of the three dimensional printing system including the transport system, the print engine, and the spinning system. The controller can be at a single location or can be distributed at various locations within or outside of the printing system.

In another implementation the three dimensional printing system can include a variety of functional modules including, for example, one or more of a rinse station, a dry station, a cure station, an inspection station, and a storage container for storing full support trays. The functional modules can be integrated into a table. The functional modules can also be integrated or separate—for example, the rinse module can be integrated with the dry module.

In a third aspect of the disclosure, a method of manufacturing a three dimensional article includes providing, loading, and operating a spinning apparatus to remove uncured resin from the three dimensional article.

### DETAILED DESCRIPTION OF THE PREFERRED EMBODIMENTS

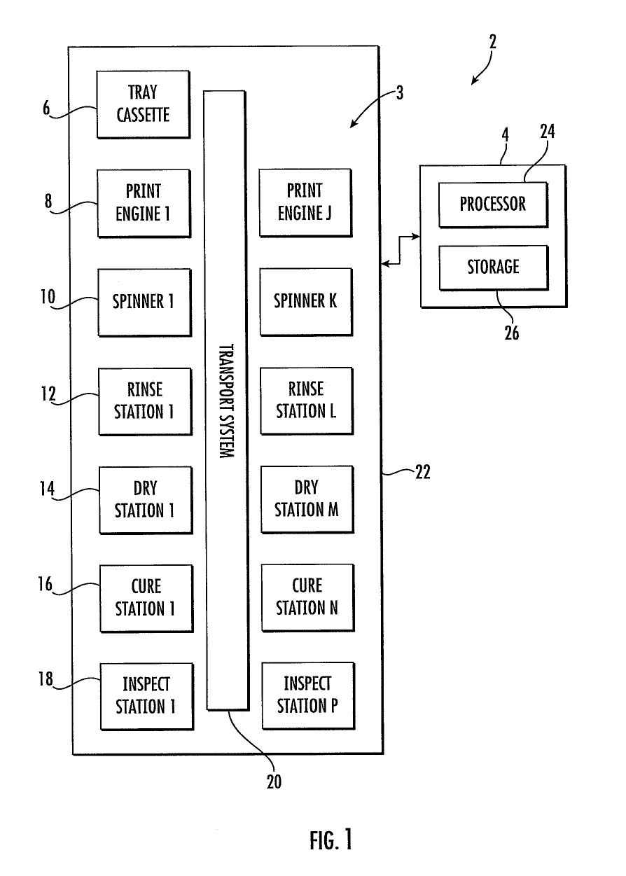

FIG. 1 is a block diagram depicting an embodiment of a three dimensional (3D) printing system 2 having various functional modules 3 under the control of a controller 4. The functional modules 3 can include a source of empty support trays 6, a print engine 8, a spinning apparatus 10, a rinse station 12, a dry station 14, a cure station 16, an inspection station 18, and a transport system 20. Also, there can be more than one of a particular type of functional module 3 to provide a desired production capacity for the printing system 2. For example, system 2 can include four or even eight print engines 8. In general, there are J print engines, K spinning apparatus, L rinse stations, M dry stations, N cure stations, and P inspection stations.

All of the functional modules 3 are mounted on table 22. The transport system 20 is configured to move support trays between the modules. Transport system 20 can include a first transport apparatus (part of element 20) which moves the support trays between modules. Transport system 20 can also include a second transport apparatus (a loading apparatus) specifically for loading a tray from the first transport apparatus into a given module 3. Thus, a particular loading apparatus can be specifically adapted to a particular functional module 3.

The controller 4 can be a server computer that is coupled to some or all of the functional modules 3. Controller 4 includes a processor 24 and an information storage device 26. Information storage device 26 includes a non-volatile or non-transient storage device storing software instructions. The software instructions are executed on the processor 24 for controlling the modules 3. Some or all of the modules 3 can also include their own controllers that are coupled to controller 4 and include processors and storage devices for executing software instructions within the functional module 3.

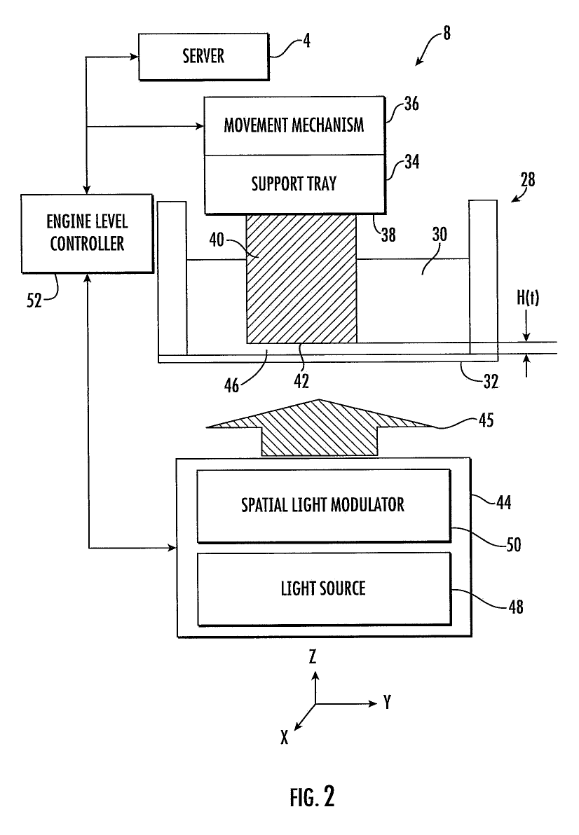

FIG. 2 is a schematic diagram an embodiment of a three dimensional print engine 8. Print engine 8 includes a resin vessel 28 containing photocurable resin 30. Resin vessel 28 includes a transparent sheet 32 at a lower end.

A support tray 34 is supported by a vertical movement mechanism 36. In the illustrated embodiment, the support tray 34 has a lower planar portion 38 upon which a three dimensional article of manufacture 40 is being formed. The three dimensional article of manufacture 40 has a lower face 42 that is in facing relation with the transparent sheet 32.

A light engine 44 transits pixelated light 45 through the transparent sheet 32 to a build plane 46 which is proximate to the lower face 42. The pixelated light 45 selectively cures photocurable resin at the build plane 46 and onto the lower face 42 of the three dimensional article of manufacture 40. The vertical movement mechanism 36 optimally positions the lower face 42 relative to the build plane 46 at a controlled distance H(t) above the transparent sheet 32. In the illustrated embodiment, the light engine 44 includes a light source 48 and a spatial light modulator 50.

An engine-level controller 52 is coupled to controller 4, the movement mechanism 36, the light engine 44, and other portions of print engine 8. Like controller 4, the engine level controller 52 has a processor and a non-volatile or non-transient storage (not shown) that stores software instructions. The software instructions are executed by the processor to control the movement mechanism 36, the light engine 44, other portions of print engine 8, and send and receive instructions and other information to and from the controller 4.

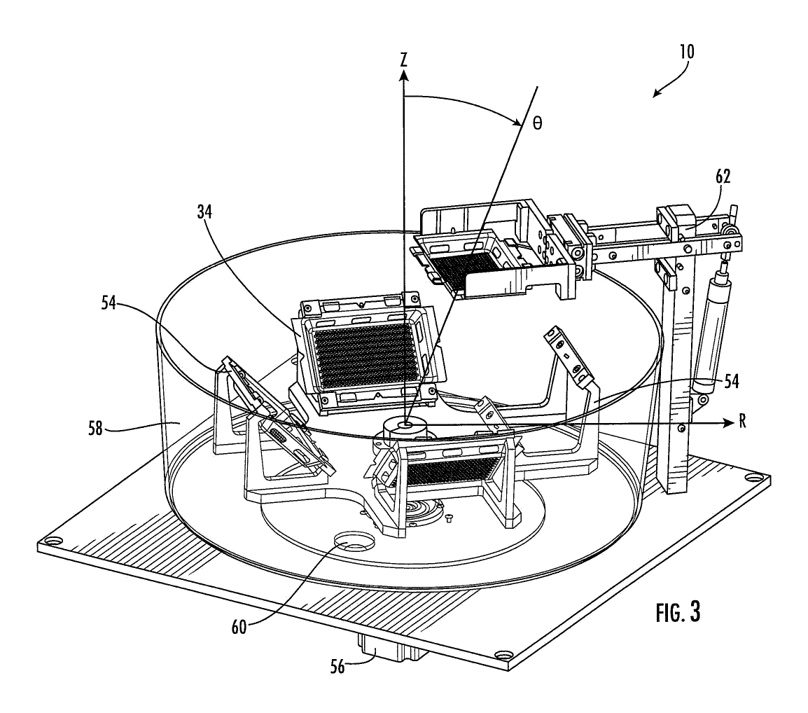

FIG. 3 is an isometric drawing of an embodiment of a spinning apparatus 10. In the following description, certain axes are useful. The axes Z, R, and theta (θ) are cylindrical coordinates and are illustrated in FIG. 3. Axis Z is a vertical central axis of rotation for the spinning apparatus 10. Axis R is a radial axis in which the variable R represents a distance from the vertical central axis Z. The polar angle theta (θ) measured relative to the vertical central axis Z. Thus a horizontal direction would be tantamount to theta (θ) equals 90 degrees. Other angles may be useful such as an azimuthal angle (ϕ) which is an angle of rotation about the Z axis. The rate change in ϕ is a magnitude of an azimuthal angular velocity ω.

The spinning apparatus 10 has a plurality of tray holders 54 that are arranged around the vertical central axis Z. The tray holders 54 have features for holding support trays 34 as will be described in more detail below. In the illustrated embodiment the spinning apparatus includes two pairs of tray holders 54 with each of a pair of tray holders 54 in opposed locations with respect to the radial axis R. The tray holders 54 are azimuthally separated by an azimuthal angle ϕ equal to 360 degrees divided by the number of tray holders 54. Thus in the illustrated embodiment the tray holders 54 are 90 degrees apart with respect to azimuthal angle ϕ.

The spinning apparatus 10 includes a motor 56 for rotating the tray holders 54 about the vertical central axis Z at an angular velocity ω to remove residual uncured photocurable resin 30 left over from the resin vessel 28 immersion. Surrounding the azimuthal arrangement of tray holders 54 is a resin shroud 58 for capturing photocurable resin 30 that is flung radially outward during the rotation. Resin shroud 58 includes drain holes 60 where the photocurable resin 30 can drain out of the shroud 58 to a resin capture system (not shown).

Also shown is a loading apparatus 62 for loading a support tray 34 into a tray holder 54. More details of loading apparatus 62 will be discussed infra.

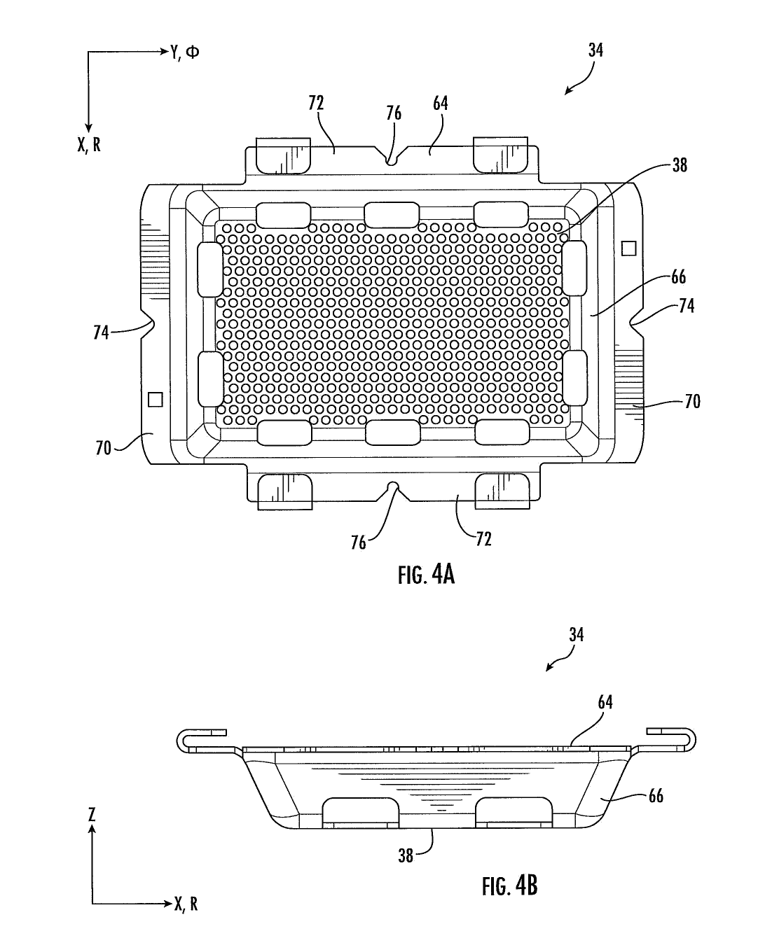

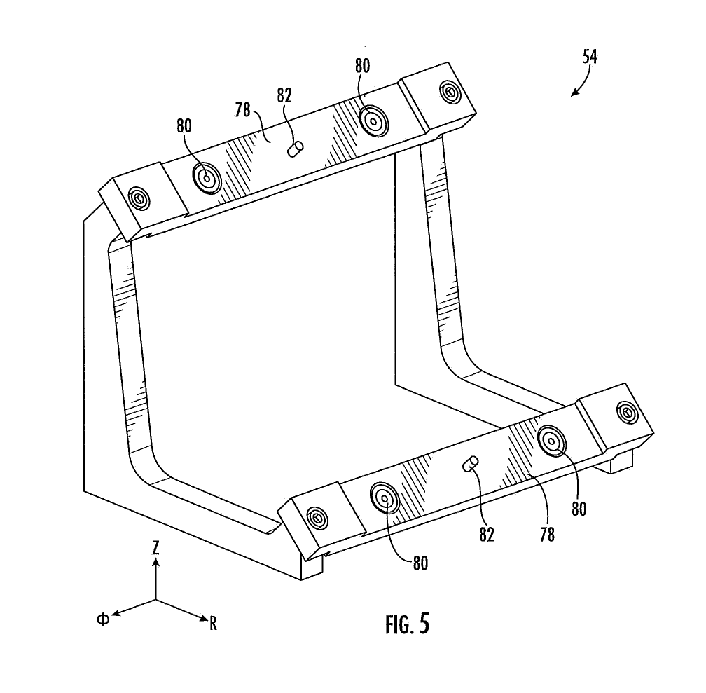

FIGS. 4A and 4B are top and side views of an embodiment of a support tray 34 respectively. Mutually perpendicular axes X, Y, and Z are shown for the support tray 34. When the support tray is in the loading apparatus 62 in the horizontal position, axis Y corresponds to the azimuthal direction ϕ and axis X corresponds to the radial direction R. The support tray 34 includes a lower planar portion 38 and an upper datum portion 64 that are connected together by a sloped portion 66. Support tray 34 is formed from a magnetic material to facilitate holding it within some or all of the functional modules 3.

The upper datum portion 64 includes two sets of datum portions 70 and 72. The two datum portions 70 extend in opposed directions with respect to Y and include datum features 74. The two datum portions 72 extend in opposed directions with respect to X and include datum features 76.

FIG. 5 is an isometric drawing of an embodiment of a tray holder 54 in isolation. Tray holder 54 includes receiving surfaces 78 for receiving the datum portions 72 of the support tray 34. Magnets 80 are for holding the datum portions 72 onto the receiving surfaces 78. Datum pins 82 are for engaging the datum features 76 to align the support tray 34 within a plane defined by the receiving surfaces 78. As indicated, the plane defines an oblique angle with respect to Z and R.

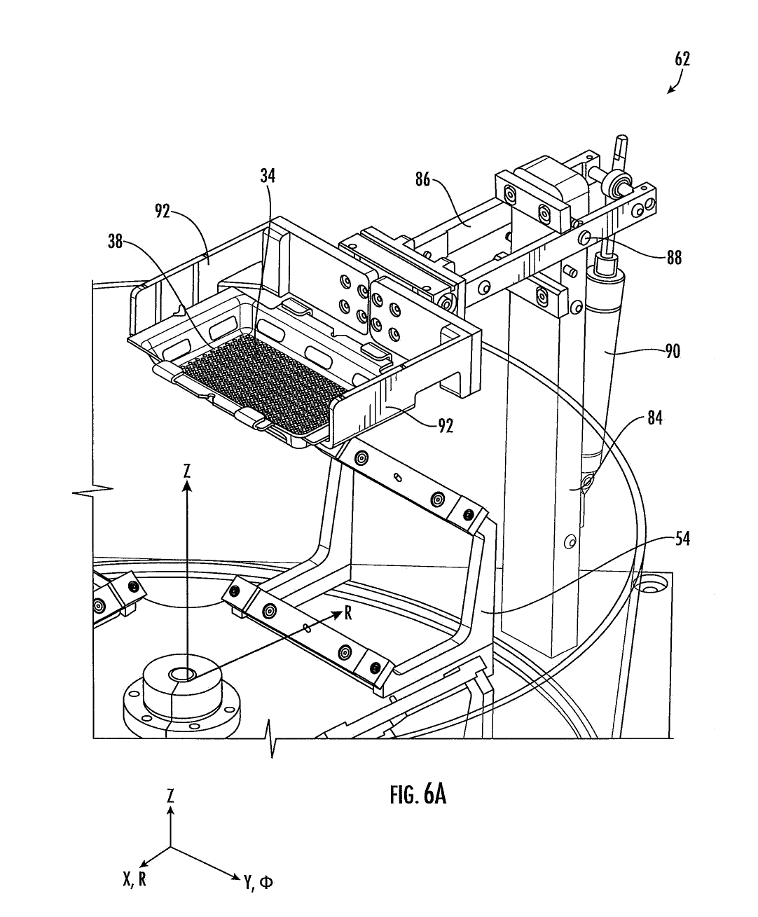

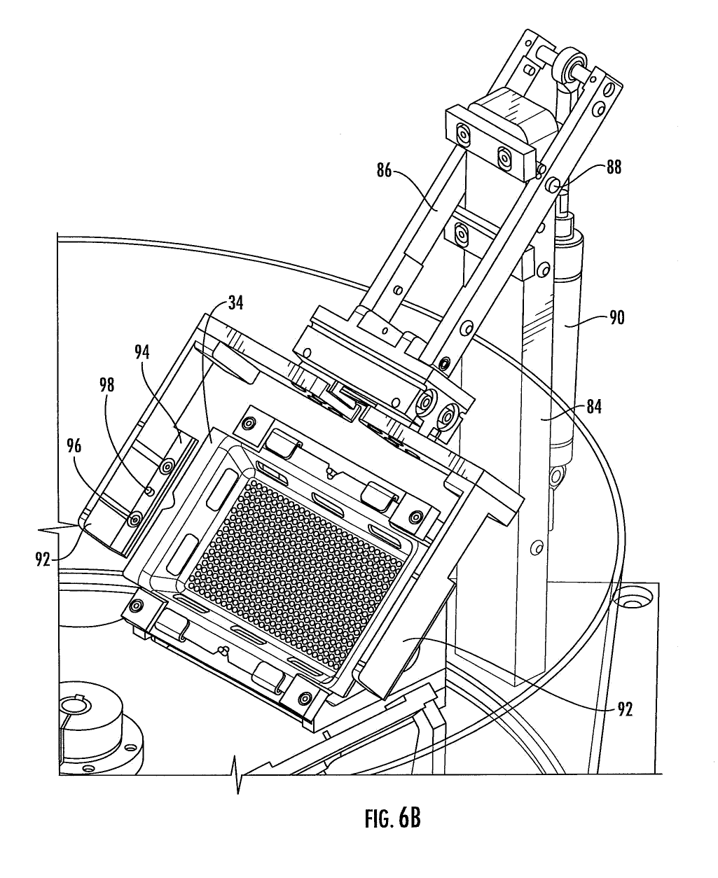

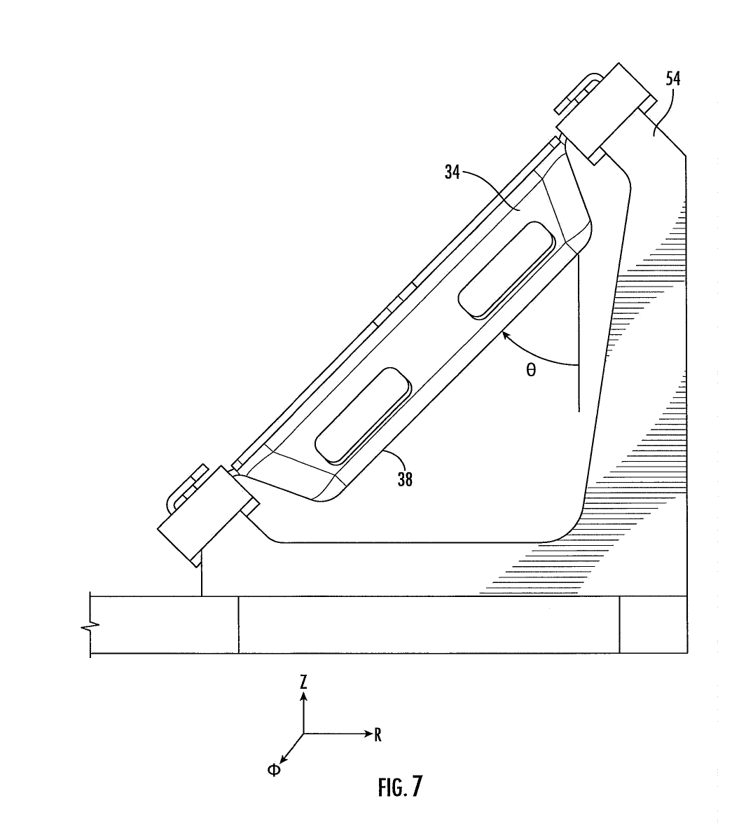

FIGS. 6A and 6B are isometric drawings that illustrate an embodiment of a loading apparatus 62 in raised (6A) and lowered (6B) positions. The loading apparatus 54 includes a fixed vertical support 84. A loading arm 86 is pivotally mounted to the fixed vertical support 84 and controllably rotates about a horizontal pivot axis 88. A pneumatic actuator 90 controllably rotates the loading arm 86 about the pivot axis 88. At a distal end of the loading arm 86 are a pair of gripping jaws 92 that move in and out along Y or the azimuthal direction ϕ. Each of the gripping jaws 92 include a receiving surface 94 for receiving one of the datum portions 70, magnets 96 for holding datum portions 70 onto receiving surfaces 94, and datum pins 98 for engaging and aligning to datum features 74.

In the raised position (6A) the gripping jaws 92 are shown closed around the datum portions 70. The lower planar portion 38 and datum portions 70 of the support tray 34 are substantially horizontal. The datum portions 70 are held onto receiving surfaces 94 by magnets 96.

In the lowered position (6B) the gripping jaws 92 are shown opened. The datum portions 72 are shown resting upon the receiving surfaces 78 and held down by magnets 80. Between the raised (6A) and lowered (6B) position, the loading arm 86 pivots about the pivot axis 88 under control of pneumatic actuator 90.

FIG. 7 is a side view of an embodiment of a tray holder 54 with an empty support tray 34 loaded thereon. The lower planar portion 38 of the support tray 34 defines a non-zero polar angle theta (θ) with the vertical axis Z. The lower planar portion 38 slopes downward from a larger value of R to a smaller value of R. In some embodiments, the value of θ is in range of 30 to 60 degrees. In the illustrated embodiment, the value of θ is about 45 degrees.

The angular motion of the loading arm 86 in moving from the raised (FIG. 6A) position to the lowered loading (6B) position correlates to the angle theta (θ) and is at least 90 degrees minus theta (θ) in the illustrated embodiment.

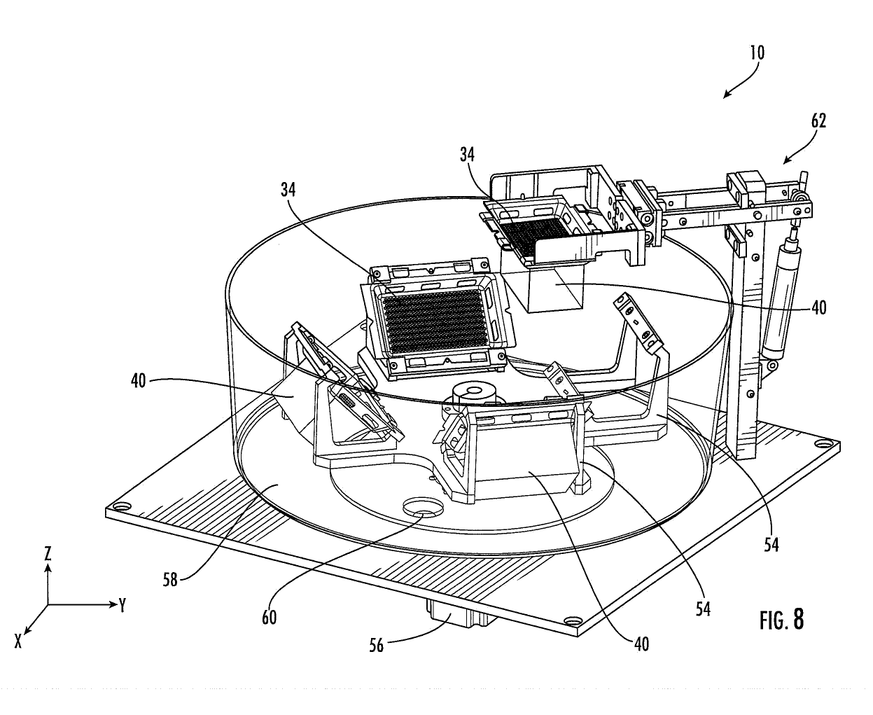

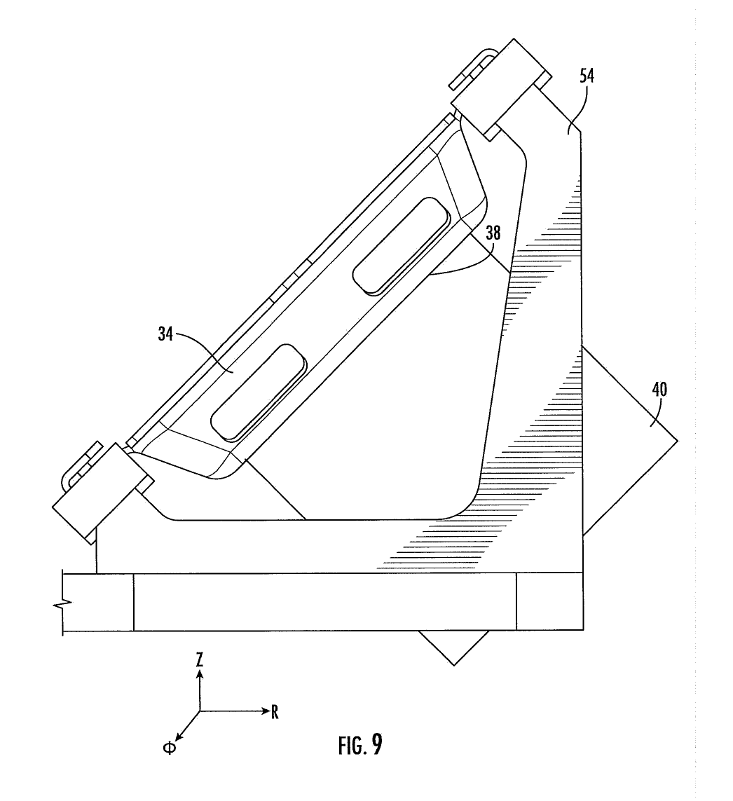

Before discussing FIGS. 8 and 9 it is useful to define “empty” and “full” support trays 34. An empty support tray 34 does not yet have a three dimensional article of manufacture 40 formed on the lower planar portion 38. A full support tray 34 has a three dimensional article of manufacture 40 formed on the lower planar portion 38.

FIG. 8 is an isometric drawing illustrating an embodiment of spinning system 10 with three out of four tray holders 54 loaded with full support trays 34. A full support tray 34 is about to be loaded into a fourth tray holder 54 using the loading apparatus 62.

FIG. 9 is an isometric drawing illustrating an embodiment of a tray holder 54 supporting a full support tray 34. As the tray holder 54 spins around the vertical central axis Z, uncured photocurable resin 30 is flung radially from the three dimensional article of manufacture 40. The non-zero polar angle of the lower planar portion 38 from a vertical direction parallel to Z prevents uncured photocurable resin 30 from dripping onto portions of the support tray 34.

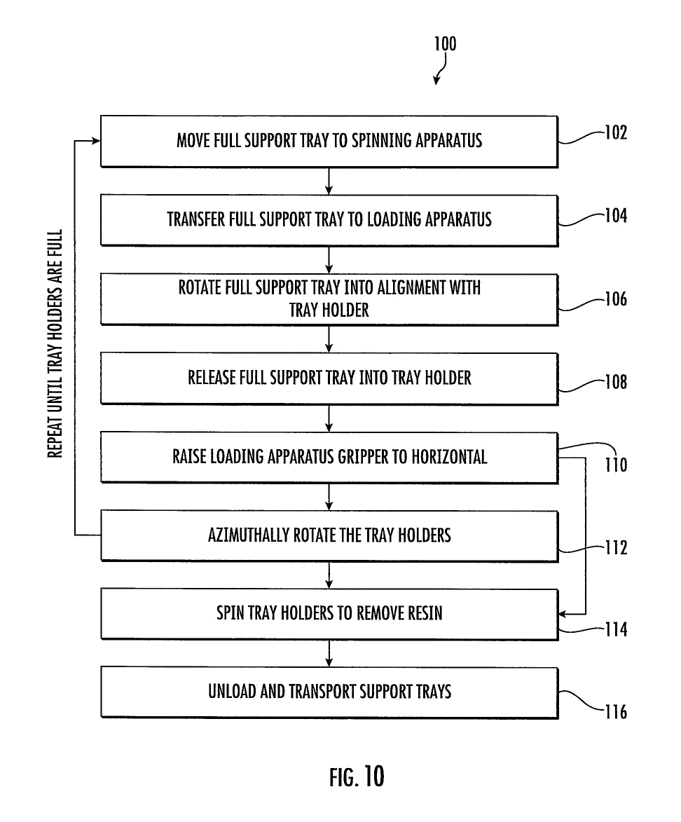

FIG. 10 is a flowchart depicting an exemplary method 100 of loading and operating the spinning system 10. Before these steps begin, it is to be understood that one or more print engines 8 have been receiving empty support trays 34 and forming three dimensional articles of manufacture 40 onto them. The spinning system is empty before method 100.

According to step 102, a full support tray 34 is transported by the first transport apparatus of the transport system 20 from a print engine 8 to the spinning system 10. According to step 104, the full support tray 34 is transferred from the first transport apparatus to the gripping jaws 92 of the loading apparatus 62 while in the raised position (FIG. 6A).

According to step 106, the loading arm 86 is rotated downwardly about the pivot axis 88 whereby the gripping jaws 92 move the support tray 34 into alignment with the tray holder 54 (FIG. 6B). According to step 108, the gripping jaws 92 are moved outwardly away from the datum portions 70. Then the datum portions 72 of the support tray 34 are held onto the receiving surfaces 78 of the tray holder 54. According to step 110, the loading arm is rotated back to the raised position. According to step 112, the tray holders 54 are azimuthally rotated in ϕ about the vertical central Z axis (about 90 degrees) until an empty tray holder is under the loading apparatus 62.

Steps 102-112 are then repeated to load the next tray holder 54 and rotate the next empty tray holder under the loading apparatus. This is repeated until the last empty tray holder 54 is to be loaded. After steps 102-110 are performed to load the last empty tray holder, the method proceeds to step 114.

The tray holders 54 with the full support trays 34 are then spun to remove uncured photocurable resin 30. The spinning of step 114 generates a centrifugal force on the uncured resin whereby it is flung from the three dimensional articles of manufacture 40 and onto the shroud from which the excess resin can drip and flow toward the drain 60. When the spinning process of step 114 is complete, the full support trays 34 are unloaded from the spinning apparatus 10 and transported to another module 3 such as a rinse station 12 according to step 116.

The specific embodiments and applications thereof described above are for illustrative purposes only and do not preclude modifications and variations encompassed by the scope of the following claims.

What is claimed:

1. A three dimensional printing system including:
a source of empty support trays at least some trays including:
a lower planar portion; and
an upper datum portion;
a print engine configured to receive an empty support tray and to form a three dimensional article of manufacture onto the lower planar portion to provide a full support tray;
a spinning apparatus including a plurality of tray holders arranged around a vertical axis of rotation including a tray holder having receiving surfaces for receiving the upper datum portion of the full support tray and a motor for rotating the tray holders about the vertical axis of rotation; and
a transport system configured to transfer the empty support tray from the source of support trays to the print engine and to transfer the full support tray from the print engine to the tray holder.

2. The three dimensional printing system of claim 1 wherein the support tray is formed from a magnetic material and the tray holder includes a magnet for securing the full support tray to the tray holder.

3. The three dimensional printing system of claim 1 wherein the upper datum portion includes two sets of datum portions including a first set of opposed datum portions that extend along a first axis and a second set of opposed datum portions that extend along a second axis that is perpendicular to the first axis, the first set of datum portions is used by the transport system to hold the full support tray as it is placed into the tray holder, the second set of datum portions engaging the receiving surfaces of the tray holder.

4. The three dimensional printing system of claim 3 wherein the second set of datum portions are opposed with respect to a radial axis that extends from the vertical axis.

5. The three dimensional printing system of claim 1 wherein the transport system includes a first transport mechanism for moving the support tray between the print engine and the spinning system and a second transport mechanism for loading the support tray into the tray holder.

6. The three dimensional printing system of claim 5 wherein the second transport mechanism includes a loading arm that rotates about a single pivot axis to move the support tray from above the spinning apparatus to the tray holder.

7. The three dimensional printing system of claim 1 wherein the tray holder defines a plane of orientation for the lower planar portion in the spinning apparatus, the plane of orientation has a non-zero polar angle with respect the vertical axis.

8. The three dimensional printing system of claim 7 wherein the polar angle is within a range of 30 to 60 degrees.

9. The three dimensional printing system of claim 7 wherein the polar angle is about 45 degrees.

10. The three dimensional printing system of claim 7 wherein the transport system includes a loading arm that rotates about a single axis to move the tray from above the spinner to the tray holder, the angle of rotation substantially correlates to the polar angle.

11. The three dimensional printing system of claim 10 wherein the angle of rotation is at least about 90 degrees minus the polar angle.

12. A three dimensional printing system including:
a source of empty support trays at least some trays including:
a lower planar portion; and
an upper datum portion;
a print engine;
a spinning apparatus including a plurality of tray holders arranged around a vertical axis of rotation and coupled to a motor system and including a tray holder having receiving surfaces;
a transport system; and
a controller configured to:
operate the transport system to transfer an empty support tray from the source of support trays to the print engine;
operate the print engine to form a three dimensional article of manufacture onto a lower surface of the planar portion thereby providing a full support tray;
operate the transport system to transfer the full support tray from the print engine to the tray holder whereby the upper datum portion engages the receiving surfaces; and
operate the motor system to rotate the tray holders about the vertical axis and to thereby remove uncured resin from the three dimensional article of manufacture.

13. The three dimensional printing system of claim 12 wherein the upper datum portion includes two sets of datum portions including a first set of opposed datum portions that extend along a first axis and a second set of opposed datum portions that extend along a second axis that is perpendicular to the first axis, the first set of datum portions is used by the transport system to hold the full support tray as it is placed into the tray holder, the second set of datum portions engaging the receiving surfaces of the tray holder.

14. The three dimensional printing system of claim 13 wherein the second set of datum portions are opposed with respect to a radial axis of the rotational motion of the tray holders.

15. The three dimensional printing system of claim 12 wherein the receiving surfaces of the tray holder define a non-zero polar angle of orientation of the planar portion of the support tray with respect to the vertical axis.

16. The three dimensional printing system of claim 15 wherein the polar angle is in a range of about 30 to 60 degrees.

17. The three dimensional printing system of claim 15 wherein the transport system includes a loading arm that rotates about a single axis to move the tray from above the spinner to the tray holder, the angle of rotation correlates with the polar angle.

18. A method of manufacturing a three dimensional article of manufacture with a printing system including a print engine comprising:
providing a spinning apparatus including a plurality of tray holders and a motor system for rotating the plurality of tray holders about a vertical axis of rotation, the plurality of tray holders including a tray holder defining a non-zero polar angle with respect to the vertical axis;
transporting a support tray having a three dimensional article of manufacture attached to a support surface including rotating the support surface from a substantially horizontal orientation to an oblique angle while loading the support tray into the tray holder whereby the support surface is oriented at the non-zero polar angle with respect to the vertical axis; and
rotating the tray holder about the vertical axis to remove uncured resin from the three dimensional article of manufacture.

19. The method of claim 18 wherein the support tray includes two sets of datum portions including a first set of opposed datum portions that extend along a first axis and a second set of opposed datum portions that extend along a second axis that is perpendicular to the first axis and the method includes:
holding the support tray by the first set of opposed datum portions while moving the support tray from above the spinning apparatus to the tray holder; and
holding the support tray by the second set of opposed datum portions while rotating the tray holders about the vertical axis.

20. The method of claim 18 wherein the polar angle is between 30 and 60 degrees.
